(19) United States
(12) Patent Application Publication
(10) Pub. No.: US 2018/0305956 A1
(43) Pub. Date: Oct. 25, 2018

(54) TRIGGERING STRUCTURE FOR ELECTRONIC LOCK, ELECTRONIC LOCK AND TRIGGERING METHOD THEREOF

(71) Applicant: WUHAN PULINGUANGTONG TECHNOLOGY CO., LTD., Wuhan, Hubei (CN)

(72) Inventors: Jia LI, Wuhan (CN); Qingtong ZENG, Wuhan (CN); Zhiguo XU, Wuhan (CN)

(73) Assignee: WUHAN PULINGUANGTONG TECHNOLOGY CO., LTD., Wuhan, Hubei (CN)

(21) Appl. No.: 15/765,984

(22) PCT Filed: Oct. 14, 2016
(86) PCT No.: PCT/CN2016/102148

§ 371 Date: Apr. 4, 2018

(30) Foreign Application Priority Data
Dec. 1, 2015 (CN) 201510859985.8

(51) Int. Cl. E05B 47/02; E05B 17/22

(52) U.S. Cl. CPC E05B 47/02; E05B 17/10; E05B 17/22

(57) ABSTRACT

A triggering structure for an electronic lock includes a reed switch which is mounted on the lock body base and of which an ON-and-OFF state is acquired by an electronic lock control system, a permanent magnet for controlling the ON-and-OFF state of the reed switch, and a lever which passes through a handle and is mounted on the handle, ends of the lever each extending out of the surface and back face of the handle, the permanent magnet being attached to the end of the lever extending out of the back face of the handle. Also, an electronic lock and a triggering method thereof.

### FIELD OF THE INVENTION

The present disclosure is related to an electronic lock, in particular a triggering structure for the electronic lock, the electronic lock and a triggering method thereof.

### BACKGROUND OF THE INVENTION

With the development of information technology and improvement of user management requirement, access control of a industrial cabinet is requested to a higher degree by industrial cabinets users at present. It is widely hoped that a access control system for the cabinet is under efficient management and control using modern control means; when an electronic lock system is designed, it is commonly considered that the access control system is triggered by a triggering method; it is proposed by some manufacturers that a micro-switch which is triggered due to 1˜2 mm of small distance of a trigger rod is mounted on a lock body. This solution brings about in practical application problems, such as weak waterproof and damage resistant abilities, low reliability of overall design and a high false alarm rate.

### SUMMARY OF THE INVENTION

For overcoming the above deficiencies, an object of the present disclosure is to provide a triggering structure for an electronic lock, the electronic lock and a triggering method thereof for this art, so as to solve the above technical problems present in conventional locks. The object is achieved by the following solutions.

A triggering structure for an electronic lock is provided in the present disclosure, wherein the electronic lock comprises a lock body base; a handle of which an end is movably connected with the lock body base; in an initial state, the handle is closed in the lock body base such that the electronic lock is in a closed state; the triggering structure for the electronic lock comprising: a reed switch which is mounted on the lock body base and of which an ON-and-OFF state is acquired by an electronic lock control system, a permanent magnet for controlling the ON-and-OFF state of the reed switch, and a lever which passes through the handle and is mounted on the handle, ends of the lever each extending out of the surface and back face of the handle, the permanent magnet being attached to the end of the lever extending out of the back face of the handle.

From above, because of use of the reed switch and the permanent magnet, higher reliability and a lower false alarm rate is achieved as compared with the micro-switch mentioned in the Background of The Invention; because the reed switch is located on the lock body base and the permanent magnet is disposed on the back face of the handle, waterproof and damage resistant abilities are improved; and the space of the handle in the type of electronic lock is utilized effectively.

Optionally, the reed switch is mounted on a circuit board in electrical communication with the electronic lock control system and is mounted together with the circuit board on the lock body base,

alternatively, the reed switch is individually mounted on the lock body base and is connected to the circuit board via a wire.

Optionally, the handle has a through groove which extends along the surface of the handle in any direction, the lever passing through the through groove is slidingly connected with the handle, such that the position of the permanent magnet relative to the reed switch changes when the lever slides.

From above, triggering of the electronic lock can be controlled by pushing the lever along the through groove on the handle upwards/downwards, or toward left/right, or in other directions set.

Optionally, the lever passing through the handle is rotatably connected with the handle, the permanent magnet is attached by deflecting from an axial direction of the lever such that the position of the permanent magnet relative to the reed switch changes when the lever is rotated.

From above, the electronic lock can be triggered by way of rotating the lever.

Optionally, the handle has a through hole, the lever passing through the through hole is attached in a sliding connection with the handle along an axial direction of the through hole such that the distance position of the permanent magnet relative to the reed switch changes when the lever slides.

From above, the electronic lock can be triggered by way of pulling laterally the lever outwards or pushing laterally the lever inwards.

Optionally, the triggering structure further comprises a return spring which is mounted on the back face of the handle such that the lever or the permanent magnet can return to its original position.

The present disclosure also provides an electronic lock comprising the triggering structure for an electronic lock according to any one of above descriptions.

The present disclosure also provides a triggering method of the triggering structure for an electronic lock according to any one of above descriptions, comprising: causing the position of the permanent magnet on the lever relative to the reed switch to change by manipulating the lever, in order to affect the change in the ON-and-OFF state of a circuit of the reed switch to trigger the electronic lock.

Optionally, the change in the ON-and-OFF state of the circuit includes one of the following processes: a process in which the circuit is switched to OFF from ON, or a process in which the circuit is switched to ON from OFF, or a cycle process in which the circuit is switched between ON and OFF.

It can be seen that because of a triggering structure for an electronic lock and a triggering method thereof in the disclosure, the space of the handle in the type of the electronic lock is utilized effectively, in combination of the lever and the permanent magnet, a triggering method and a triggering structure for said type of the electronic lock is better accomplished due to effect of the permanent magnet on the reed switch. The requirement for this type of the electronic lock in the market at present can be satisfied so that the products brings about a greater promotion value.

### BRIRF DESCRIPTION OF THE DRAWINGS

FIG. 1 is a structurally schematic diagram of an electronic lock in the disclosure in an exploded view;

FIG. 2 is a structurally schematic diagram of the interior of an electronic lock in the disclosure;

FIG. 3 is a structurally schematic diagram of the interior of an electronic lock in the disclosure when the triggering structure for the electronic lock is triggered;

FIG. 4 is a structurally schematic diagram of another triggering structure for an electronic lock in the disclosure.

In the drawings, 1-lock body base, 2-handle, 3-lever, 4-permanent magnet, 5-reed switch, 6-return spring, 7-circuit board, 8-rotating shaft, 9-through groove.

### DETAILED DESCRIPTION OF THE PREFERRED EMBODIMENT

Technical solutions in embodiments of the disclosure will be explained clearly and completely hereinafter with reference to the drawings. It is apparent that the embodiments described herein are only part of the embodiments of the present disclosure, but not all of the embodiments. Based on the embodiments of the present disclosure, all other embodiments acquired by one of ordinary skill in the art under the premise of no creative work are in each case within the protection scope of the disclosure.

For the convenience of understanding the contents of this disclosure, a particular electronic lock used in the industrial occasion will be described below. It is understood that a triggering structure for an electronic lock and a triggering method thereof are not only limited in this type of industrial locks but also satisfy the requirement of more other application occasions of electronic locks. In this regard, it should not be regarded as a limitation to the disclosure, but should be in each case within the protection scope of the disclosure.

In the disclosure, orientations such as upper end, lower end, upwards and downwards, etc. in the FIG. 1-FIG. 4 are all defined with reference to the orientations illustrated in FIG. 1 in the case that there is no specific limitations. In FIG. 1, the upper side/lower side after tilting clockwise is the upper side/lower side described hereinafter.

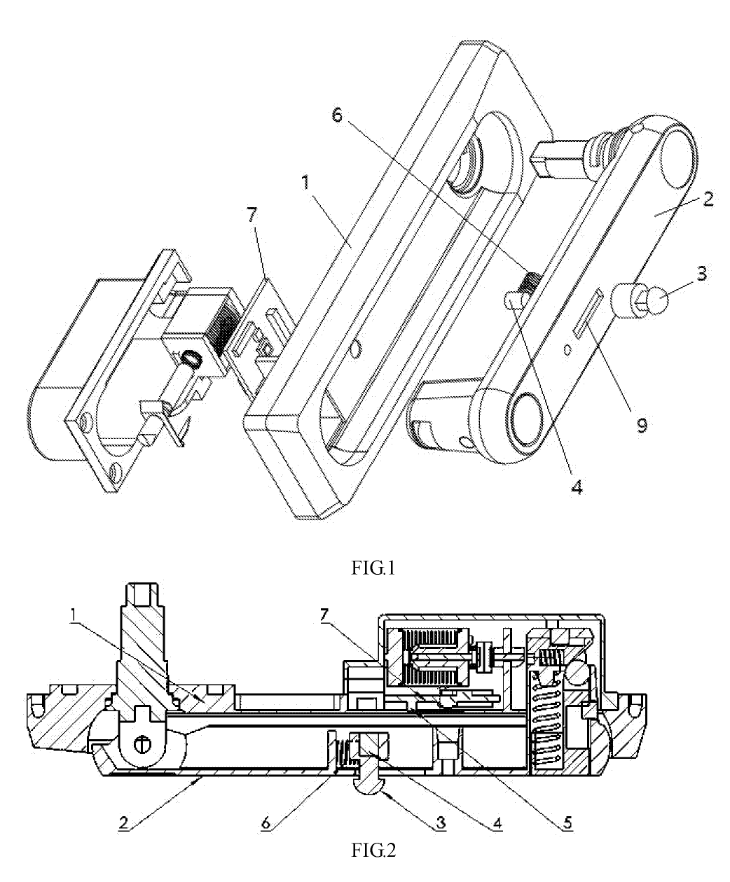

Structurally schematic diagrams of a particular electronic lock in the disclosure are illustrated in FIG. 1 to FIG. 2 in an exploded view and an overall view, respectively. As seen from the figures, the electronic lock is composed of a lock body base together with a handle of which an upper end is movably connected with the lock body base, thereby a lower end of the handle can be rotated in a direction away from the lock body base. A reed switch is mounted on a circuit board on the back of the lock body base. A through groove is disposed on the handle. A lever is mounted in the through groove. A permanent magnet is mounted to the back end of the lever and located on the back face of the handle. A return spring is arranged in parallel to the back face of the handle, one end of the return spring is connected to the back of the handle, the other end is connected to the lever. In an initial state, the handle is closed in the lock body base and in a closed state, at this moment the lever is located on an upper end of the through groove and the permanent magnet is in a certain distance from the reed switch and then the reed switch is in an OFF state.

It is understood that the reed switch as illustrated in FIG. 2 can also be mounted individually on the lock body base so as to join the circuit board or an electronic lock control system via a wire, in this regard all the above should belong to the protection scope of the disclosure.

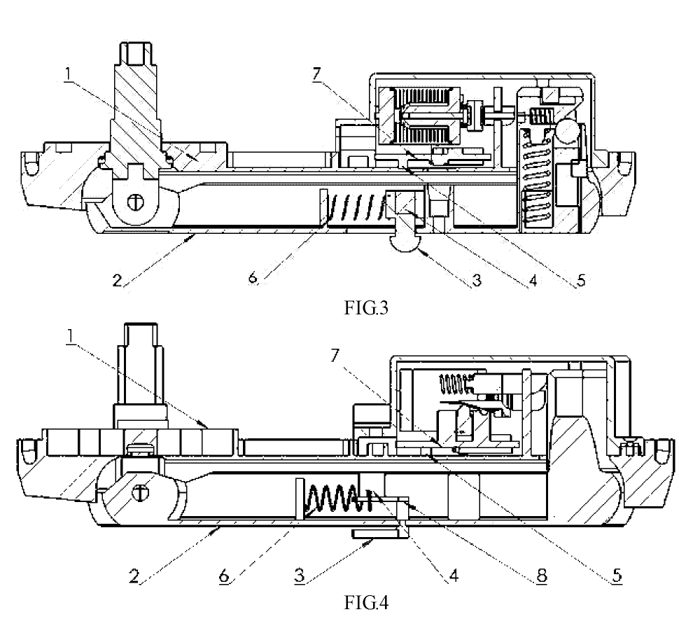

Refer to FIG. 3 which is a structurally schematic diagram of the interior of an electronic lock in a triggering method in the disclosure when the triggering structure for the electronic lock is triggered. It can be seen that the lever is moved downwards to stretch the return spring. The permanent magnet on the back end of the lever is shifted downwards therewith and come to be close to the reed switch gradually. At this moment, the reed switch would be affected by the magnetism of the permanent magnet and its circuit would be switched from an OFF state to an ON state. After releasing the lever, the lever is pulled upwards by the return spring, and then the triggering structure for the electronic lock is restored to the original state.

It is understood that there can be a variety of forms of the triggering structure for the electronic lock, the shifting ways of the lever, for example, can be changed to shifting upwards, or to shifting toward left/right. Each of the shifting ways can result in displacement of the permanent magnet located on the back end of the lever and then affect changes in the ON/OFF state of the circuit of the reed switch. In addition, for the triggering structure, there is another embodiment, for example, a rotating shaft on the back face of the handle is driven by a rotating lever. The permanent magnet is located on the rotating shaft and then is rotated therewith, as illustrated in FIG. 4 that is the above mentioned structurally schematic diagram of the another triggering structure for the electronic lock in the disclosure. In this regard, all other implementation means for the type of triggering structure acquired by one of ordinary skill in the art under the premise of no creative work are in each case within the protection scope of the disclosure.

It is understood that although in the triggering method of the electronic lock, the circuit of the reed switch is in the OFF state in the initial state, the circuit of the reed switch may be also set in the ON state for the practical application, in which the circuit of the reed switch is switched from the ON state to the OFF state after the permanent magnet is close to the reed switch; or the circuit of the reed switch is caused to be in a cycle process between ON and OFF following a change of the distance between the permanent magnet and the reed switch. In this regard, it is understood by those of ordinary skill in the art that whether the circuit of the reed switch is in the OFF state or is in the ON state in the initial state does not lead to a substantive difference for a triggering method of an electronic lock in the disclosure, that is, in each case any state in the initial state is within the protection scope of the disclosure.

It is understood that in the triggering method of the electronic lock, the relative positions of the reed switch and the permanent magnet may be close in the initial state. The permanent magnet is gradually away from the reed switch after shifting the lever, and then the effect on the ON/OFF states of circuit of the reed switch is finally eliminated; or the permanent magnet is caused to be close to/away from the reed switch after shifting the lever, and then the permanent magnet is caused to be away from/close to the reed switch after continuing to shift the lever, such that the circuit of the reed switch is either switched from OFF to ON, and then back to OFF, or switched from ON to OFF and then back to ON. In this regard, it is understood to those of ordinary skill in the art that the relative positions of the reed switch and the permanent magnet in the initial state does not change the effect of the permanent magnet on the reed switch by shifting of the lever in the disclosure and therefore does not lead to a substantive difference for the triggering method, that is, mentioned relative positions are in each case within the protection scope of the disclosure.

It is understood that in this type of electronic locks, there is commonly a permanent magnet in a fixed position on the handle. A reed switch mounted on the lock body base is used to detect if the handle is closed on the lock body base. While in the present disclosure, another permanent magnet which has magnetic repulsion relative to the permanent magnet in the fixed position and which is moved along with the lever is used to affect the effect of the permanent magnet in the fixed position on the reed switch, leading to a change in the ON/OFF states of the circuit with the reed switch, or leading to a periodicity change in the ON/OFF states of the circuit of the reed switch. All of those can cause the electronic locks to be triggered. In this regard, they should be in each case within the protection scope of the disclosure.

Due to the triggering structure for the electronic lock, the electronic lock and the triggering method thereof in the disclosure, the space of the handle in the type of the electronic lock is utilized effectively, in combination of the lever and the permanent magnet, a triggering structure and a triggering method in the type of the electronic lock is better accomplished due to effect of the permanent magnet on the reed switch. The requirement for this type of the electronic lock in the market at present can be satisfied so that the products brings about a greater promotion value.

However, the above mentioned are only preferred feasible embodiments in the disclosure, not limitation to the protection scope of the disclosure, so any equivalent structural variation using content of the specification and the accompanying drawings of the disclosure is in each case included within the protection scope of the disclosure.

1-9. (canceled)

10. A triggering structure for an electronic lock, wherein the electronic lock comprises a lock body base; a handle of which an end is movably connected with the lock body base; in an initial state, the handle is closed in the lock body base such that the electronic lock is in a closed state; the triggering structure for the electronic lock comprising:
a reed switch which is mounted on the lock body base and of which an ON-and-OFF state is acquired by an electronic lock control system, a permanent magnet for controlling the ON-and-OFF state of the reed switch, and a lever which passes through the handle and is mounted on the handle, ends of the lever each extending out of the surface and back face of the handle, the permanent magnet being attached to the end of the lever extending out of the back face of the handle.

11. The triggering structure for an electronic lock according to claim 10, wherein the reed switch is mounted on a circuit board in electrical communication with the electronic lock control system and is mounted together with the circuit board on the lock body base,
alternatively, the reed switch is individually mounted on the lock body base and is connected to the circuit board via a wire.

12. The triggering structure for an electronic lock according to claim 10, wherein the handle has a through groove which extends along the surface of the handle in any direction, the lever passing through the through groove is slidingly connected with the handle such that the position of the permanent magnet relative to the reed switch changes when the lever slides.

13. The triggering structure for an electronic lock according to claim 10, wherein the lever passing through the handle is rotatably connected with the handle, the permanent magnet is attached by deflecting from an axial direction of the lever such that the position of the permanent magnet relative to the reed switch changes when the lever is rotated.

14. The triggering structure for an electronic lock according to claim 10, wherein the handle has a through hole, the lever passing through the through hole is attached in a sliding connection with the handle along an axial direction of the through hole such that the distance position of the permanent magnet relative to the reed switch changes when the lever slides.

15. The triggering structure for an electronic lock according to claim 10, further comprising a return spring which is mounted on the back face of the handle such that the lever or the permanent magnet can return to its original position.

16. The triggering structure for an electronic lock according to claim 11, further comprising a return spring which is mounted on the back face of the handle such that the lever or the permanent magnet can return to its original position.

17. The triggering structure for an electronic lock according to claim 12, further comprising a return spring which is mounted on the back face of the handle such that the lever or the permanent magnet can return to its original position.

18. The triggering structure for an electronic lock according to claim 13, further comprising a return spring which is mounted on the back face of the handle such that the lever or the permanent magnet can return to its original position.

19. The triggering structure for an electronic lock according to claim 14, further comprising a return spring which is mounted on the back face of the handle such that the lever or the permanent magnet can return to its original position.

20. An electronic lock, comprising the triggering structure for the electronic lock according to claim 10.

21. A triggering method of the triggering structure for an electronic lock according to claim 10, comprising: causing the position of the permanent magnet on the lever relative to the reed switch to change by manipulating the lever, in order to affect the change in the ON-and-OFF state of a circuit of the reed switch to trigger the electronic lock.

22. The triggering method according to claim 21, wherein the change in the ON-and-OFF state of the circuit includes one of the following processes:
a process in which the circuit is switched to OFF from ON, or a process in which the circuit is switched to ON from OFF, or a cycle process in which the circuit is switched between ON and OFF.

23. The triggering method according to claim 21, wherein the reed switch is mounted on a circuit board in electrical communication with the electronic lock control system and is mounted together with the circuit board on the lock body base,
alternatively, the reed switch is individually mounted on the lock body base and is connected to the circuit board via a wire.

24. The triggering method according to claim 21, wherein the handle has a through groove which extends along the surface of the handle in any direction, the lever passing through the through groove is slidingly connected with the handle such that the position of the permanent magnet relative to the reed switch changes when the lever slides.

25. The triggering method according to claim 21, wherein the lever passing through the handle is rotatably connected with the handle, the permanent magnet is attached by deflecting from an axial direction of the lever such that the position of the permanent magnet relative to the reed switch changes when the lever is rotated.

26. The triggering method according to claim 21, wherein the handle has a through hole, the lever passing through the through hole is attached in a sliding connection with the handle along an axial direction of the through hole such that the distance position of the permanent magnet relative to the reed switch changes when the lever slides.

27. The triggering method according to claim 21, further comprising a return spring which is mounted on the back face of the handle such that the lever or the permanent magnet can return to its original position.
